(19) United States
(12) Patent Application Publication
(10) Pub. No.: US 2024/0004448 A1
(43) Pub. Date: Jan. 4, 2024

(54) PLATFORM EFFICIENCY TRACKER

(71) Applicants: Advanced Micro Devices, Inc., Santa Clara, CA (US); ATI Technologies ULC, Markham (CA)

(72) Inventors: Ashish Jain, Austin, TX (US); Eric D. Meyer, Markham (CA); Austin Hung, Markham (CA); Tianshu Liu, Markham (CA)

(21) Appl. No.: 17/853,759

(22) Filed: Jun. 29, 2022

(51) Int. Cl. G06F 1/28; G06F 11/30

(52) U.S. Cl. CPC G06F 1/28; G06F 11/3062

(57) ABSTRACT

Systems, apparatuses, and methods for dynamically estimating power losses in a computing system. A system management circuit tracks a state of a computing system and dynamically estimates power losses in the computing system based in part on the state. Based on the estimated power losses, power consumption of the computing system is estimated. In response to detecting reduced power losses in at least a portion of the computing system, the system management circuit is configured to increase a power-performance state of one or more circuits of the computing system while remaining within a power allocation limit of the computing system.

### BACKGROUND

### Description of the Related Art

During the design of a computer or other processor-based system, many design factors must be considered. A successful design may require a variety of tradeoffs between power consumption, performance, thermal output, and so on. For example, the design of a computer system with an emphasis on high performance may allow for greater power consumption and thermal output. Conversely, the design of a portable computer system that is sometimes powered by a battery may emphasize reducing power consumption at the expense of some performance. Whatever the particular design goals, a computing system typically has a given amount of power available to it during operation. This power must be allocated amongst the various components within the system—a portion is allocated to the central processing circuit, another portion to the memory subsystem, a portion to a graphics processing circuit, and so on. How the power is allocated amongst the system components may also change during operation.

Computers and other complex electronic systems are typically designed with thermal and power budgets. Power consumption and thermal output must be held within certain limits. However, power consumption and thermal output maximums are parameters that must be considered in context of system performance requirements. If power and thermal requirements are weighed too heavily in the design of a system, performance targets may become unreachable. Conversely, giving too much weight to performance may result in power and thermal targets to be exceeded. Since the variance in required processing loads can result in a wide variance in power consumption and thermal output, many processors have the capability of making adjustments to operating voltage and operating clock frequency. This allows for control over power consumption and thermal output, and may allow these parameters to meet design requirements.

When a computing system is designed, a total amount of power required and available is determined. For example, a central processing circuit may be determined to have a certain range of power requirements, a memory subsystem is determined to have certain power requirements, and so on. The computing system power requirement is then determined based on requirements of all the components of the system. Generally speaking, components within the computing system have inefficiencies which result in power loss. For example, voltage regulators, board traces, fans, and other components within the system are not perfectly efficient with regard to power consumption. In order to account for such inefficiencies, assumptions are made at the time of design regarding how much power loss exists and how much will actually be available. For example, at design time it may be determined that voltage regulators in the system are between 80-95% efficient when operating under varying conditions. Because the system designer must account for all conditions, a conservative assumption is made that the voltage regulators are 80% efficient and total available board power is determined based on this assumption. Making a conservative assumptions ensures adequate power will always be available. However, during actual system operation, the efficiency is not always 80%. Sometimes the efficiency is higher and more power may actually be available than assumed. Consequently, power that could otherwise be used to increase performance of the system goes unused and performance is unnecessarily limited.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of another implementation of a computing system.

FIG. 3 is a chart illustrating power losses in a system.

FIG. 4 is a block diagram of one implementation of a system management circuit.

FIG. 5 is a generalized flow diagram illustrating one implementation of a method tracking power losses and changing power-performance states in a system.

FIG. 6 is a generalized flow diagram illustrating one implementation of a method for transferring a portion of a power budget between system components.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for tracking power efficiency in a computing system and changing power-performance states are disclosed. In this context, power efficiency refers to the percentage of total power drawn from the power supply that is actually available for use by the SoC. A computing system includes a system management circuit that estimates the power efficiency of one or more components of the system based on various system conditions. In one implementation, the system management circuit allocates power to components in the system based on determined system requirements. In one implementation, a given component is allocated a maximum usable power budget that the given component is required operate within. During operation of the computing system, various conditions are monitored. In response to detecting a first condition, it is determined that the given component is operating with an increased power efficiency and a power-performance state of the given component is increased. In various implementations, the power-performance of the given component is increased without increasing estimated power consumption. In this manner, increased performance is obtained while remaining at a given estimated power consumption level.

In one implementation, estimated power consumption by the given component is determined based in part on previously determined characterization and current operating conditions. Such characterization may be performed either pre-silicon or post-silicon. Such operating conditions may include one or more of an operating temperature, operating frequency, current being drawn, as well as others. In one implementation, a power efficiency tracking circuit is configured to generate estimates of power consumption based on a dynamic calculation using the above mentioned operating conditions and/or other parameters. In some implementations, the dynamic calculation is performed based on an equation implemented in hardware (i.e., circuitry). In other implementations, a combination of hardware and software are used to perform the calculations.

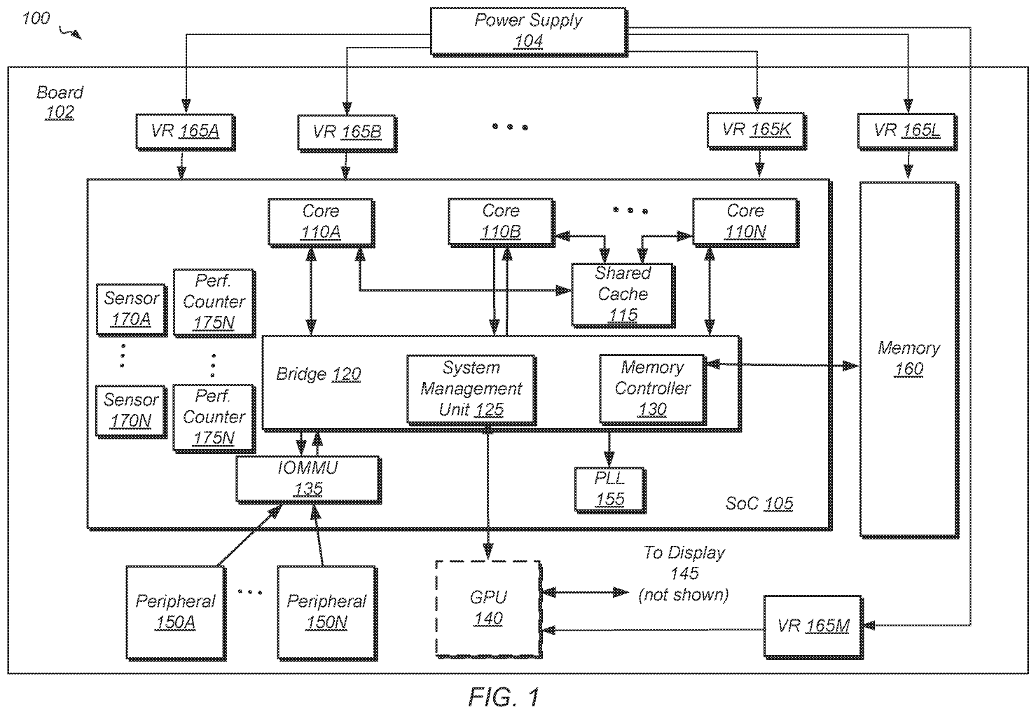

Referring now to FIG. 1, a block diagram of one implementation of a computing system 100 is shown. In the example, a power supply 104 is shown coupled to board 102 which includes components of the system. In this implementation, power supply 104 represents a total amount of power available to the board 102 and components of the system components in the system. In this implementation, the illustrated computing system 100 includes system on chip (SoC) 105 coupled to memory 160. However, embodiments in which one or more of the illustrated components of the SoC 105 are not integrated onto a single chip are possible and are contemplated. In some implementations, SoC 105 includes a plurality of processor cores 110A-N and GPU 140. In the illustrated implementation, the SoC 105, Memory 160, and other components (not shown) are part of system board 102 (e.g., a motherboard), and one or more of the peripherals 150A-150N and GPU 140 are discrete entities (e.g., daughter boards, etc.) that are coupled to the system board 102. In other implementations, GPU 140 and/or one or more of Peripherals 150 may be permanently mounted on board 102 or otherwise integrated into SoC 105. It is noted that processor cores 110A-N can also be referred to as processing circuits or processors. Processor cores 110A-N and GPU 140 are configured to execute instructions of one or more instruction set architectures (ISAs), which can include operating system instructions and user application instructions. These instructions include memory access instructions which can be translated and/or decoded into memory access requests or memory access operations targeting memory 160.

In another implementation, SoC 105 includes a single processor core 110. In multi-core implementations, processor cores 110 can be identical to each other (i.e., symmetrical multi-core), or one or more cores can be different from others (i.e., asymmetric multi-core). Each processor core 110 includes one or more execution circuits, cache memories, schedulers, branch prediction circuits, and so forth. Furthermore, each of processor cores 110 is configured to assert requests for access to memory 160, which functions as main memory for computing system 100. Such requests include read requests and/or write requests, and are initially received from a respective processor core 110 by bridge 120. Each processor core 110 can also include a queue or buffer that holds in-flight instructions that have not yet completed execution. This queue can be referred to herein as an “instruction queue.” Some of the instructions in a processor core 110 can still be waiting for their operands to become available, while other instructions can be waiting for an available arithmetic logic circuit (ALU). The instructions which are waiting on an available ALU can be referred to as pending ready instructions. In one implementation, each processor core 110 is configured to track the number of pending ready instructions.

Input/output memory management circuit (IOMMU) 135 is coupled to bridge 120 in the implementation shown. In one implementation, bridge 120 functions as a northbridge device and IOMMU 135 functions as a southbridge device in computing system 100. In other implementations, bridge 120 can be a fabric, switch, bridge, any combination of these components, or another component. A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) can be coupled to IOMMU 135. Various types of peripheral devices 150A-N can be coupled to some or all of the peripheral buses. Such peripheral devices 150A-N include (but are not limited to) keyboards, mice, printers, scanners, joysticks or other types of game controllers, media recording devices, external storage devices, network interface cards, and so forth. At least some of the peripheral devices 150A-N that are coupled to IOMMU 135 via a corresponding peripheral bus can assert memory access requests using direct memory access (DMA). These requests (which can include read and write requests) are conveyed to bridge 120 via IOMMU 135.

In some implementations, SoC 105 includes a graphics processing circuit (GPU) 140 configured to be coupled to display 145 (not shown) of computing system 100. In some implementations, GPU 140 is an integrated circuit that is separate and distinct from SoC 105. GPU 140 performs various video processing functions and provides the processed information to display 145 for output as visual information. GPU 140 can also be configured to perform other types of tasks scheduled to GPU 140 by an application scheduler. GPU 140 includes a number ‘N’ of compute circuits for executing tasks of various applications or processes, with ‘N’ a positive integer. The ‘N’ compute circuits of GPU 140 may also be referred to as “processing circuits”. Each compute circuit of GPU 140 is configured to assert requests for access to memory 160.

In one implementation, memory controller 130 is integrated into bridge 120. In other implementations, memory controller 130 is separate from bridge 120. Memory controller 130 receives memory requests conveyed from bridge 120. Data accessed from memory 160 responsive to a read request is conveyed by memory controller 130 to the requesting agent via bridge 120. Responsive to a write request, memory controller 130 receives both the request and the data to be written from the requesting agent via bridge 120. If multiple memory access requests are pending at a given time, memory controller 130 arbitrates between these requests. For example, memory controller 130 can give priority to critical requests while delaying non-critical requests when the power budget allocated to memory controller 130 restricts the total number of requests that can be performed to memory 160.

In some implementations, memory 160 includes a plurality of memory modules. Each of the memory modules includes one or more memory devices (e.g., memory chips) mounted thereon. In some implementations, memory 160 includes one or more memory devices mounted on a motherboard or other carrier upon which SoC 105 is also mounted. In some implementations, at least a portion of memory 160 is implemented on the die of SoC 105 itself. Implementations having a combination of the aforementioned implementations are also possible and contemplated. In one implementation, memory 160 is used to implement a random access memory (RAM) for use with SoC 105 during operation. The RAM implemented can be static RAM (SRAM) or dynamic RAM (DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, SoC 105 can also include one or more cache memories that are internal to the processor cores 110. For example, each of the processor cores 110 can include an L1 data cache and an L1 instruction cache. In some implementations, SoC 105 includes a shared cache 115 that is shared by the processor cores 110. In some implementations, shared cache 115 is a level two (L2) cache. In some implementations, each of processor cores 110 has an L2 cache implemented therein, and thus shared cache 115 is a level three (L3) cache. Cache 115 can be part of a cache subsystem including a cache controller.

In one implementation, system management circuit 125 is integrated into bridge 120. In other implementations, system management circuit 125 can be separate from bridge 120 and/or system management circuit 125 can be implemented as multiple, separate components in multiple locations of SoC 105. System management circuit 125 is configured to manage the power states of the various processing circuits of SoC 105. System management circuit 125 may also be referred to as a power management circuit. In one implementation, system management circuit 125 uses dynamic voltage and frequency scaling (DVFS) to change the frequency and/or voltage of a processing circuit to limit the processing circuit's power consumption to a chosen power allocation.

SoC 105 includes multiple temperature sensors 170A-N, which are representative of any number of temperature sensors. It should be understood that while sensors 170A-N are shown on the left-side of the block diagram of SoC 105, sensors 170A-N can be spread throughout the SoC 105 and/or can be located next to the major components of SoC 105 in the actual implementation of SoC 105. In one implementation, there is a sensor 170A-N for each core 110A-N, compute circuit of GPU 140, and other major components. In this implementation, each sensor 170A-N tracks the temperature of a corresponding component. In another implementation, there is a sensor 170A-N for different geographical regions of SoC 105. In this implementation, sensors 170A-N are spread throughout SoC 105 and located so as to track the temperatures in different areas of SoC 105 to monitor whether there are any hot spots in SoC 105. In other implementations, other schemes for positioning the sensors 170A-N within SoC 105 are possible and are contemplated.

SoC 105 also includes multiple performance counters 175A-N, which are representative of any number and type of performance counters. It should be understood that while performance counters 175A-N are shown on the left-side of the block diagram of SoC 105, performance counters 175A-N can be spread throughout the SoC 105 and/or can be located within the major components of SoC 105 in the actual implementation of SoC 105. For example, in one implementation, each core 110A-N includes one or more performance counters 175A-N, memory controller 130 includes one or more performance counters 175A-N, GPU 140 includes one or more performance counters 175A-N, and other performance counters 175A-N are utilized to monitor the performance of other components. Performance counters 175A-N can track a variety of different performance metrics, including the instruction execution rate of cores 110A-N and GPU 140, consumed memory bandwidth, row buffer hit rate, cache hit rates of various caches (e.g., instruction cache, data cache), and/or other metrics.

In one implementation, SoC 105 includes a phase-locked loop (PLL) circuit 155 coupled to receive a system clock signal. PLL circuit 155 includes a number of PLLs configured to generate and distribute corresponding clock signals to each of processor cores 110 and to other components of SoC 105. In one implementation, the clock signals received by each of processor cores 110 are independent of one another. Furthermore, PLL circuit 155 in this implementation is configured to individually control and alter the frequency of each of the clock signals provided to respective ones of processor cores 110 independently of one another. The frequency of the clock signal received by any given one of processor cores 110 can be increased or decreased in accordance with power states assigned by system management circuit 125. The various frequencies at which clock signals are output from PLL circuit 155 correspond to different operating points for each of processor cores 110. Accordingly, a change of operating point for a particular one of processor cores 110 is put into effect by changing the frequency of its respectively received clock signal.

An operating point for the purposes of this disclosure can be defined as a clock frequency, and can also include an operating voltage (e.g., supply voltage provided to a functional circuit). Increasing an operating point for a given functional circuit can be defined as increasing the frequency of a clock signal provided to that circuit, and can also include increasing its operating voltage. Similarly, decreasing an operating point for a given functional circuit can be defined as decreasing the clock frequency, and can also include decreasing the operating voltage. Limiting an operating point can be defined as limiting the clock frequency and/or operating voltage to specified maximum values for particular set of conditions (but not necessarily maximum limits for all conditions). Thus, when an operating point is limited for a particular processing circuit, it can operate at a clock frequency and operating voltage up to the specified values for a current set of conditions, but can also operate at clock frequency and operating voltage values that are less than the specified values.

In the case where changing the respective operating points of one or more processor cores 110 includes changing of one or more respective clock frequencies, system management circuit 125 changes the state of digital signals provided to PLL circuit 155. Responsive to the change in these signals, PLL circuit 155 changes the clock frequency of the affected processing core(s) 110. Additionally, system management circuit 125 can also cause PLL circuit 155 to inhibit a respective clock signal from being provided to a corresponding one of processor cores 110.

In the implementation shown, SoC 105 also includes multiple voltage regulators (VR) 165A-165M are included on the board 102. Each of these is coupled to one or more components within the system to provide given voltage. In other implementations, voltage regulator 165 can be implemented separately from SoC 105. In various implementations, power supply 104 represents a power supply that establishes a maximum amount of power available to the board/platform 102. Some portion of the power supplied by the power supply 104 is actually available as usable power to the SoC 105 while some portion is lost. Power loss occurs in a variety of ways in system. For example, power is lost in the transmission of power from the power supply 104 to voltage regulators 165. For example, losses occur in signal traces of the board 102 when transmitting power from one location to another. Similarly, power loss occurs within the voltage regulators 165. As is known to those skilled in the art, voltage regulators 165 are not perfectly efficient and do not convert power perfectly efficiently. Each of the components of the SoC 105 are likewise not perfectly efficient in their use of power and some power loss occurs during operation. More generally, some portion of the maximum amount of power made available by the power supply 104 is consumed by the SoC and other components of the system 100, while the rest of the power is consumed in the form of platform/power delivery losses. Consequently, some portion of the power provided by the power supply 104 is lost. Voltage regulators 165 provides a supply voltage to each of processor cores 110 and to other components of SoC 105. In some implementations, voltage regulators 165 provides a supply voltage that is variable according to a particular operating point. In some implementations, each of processor cores 110 shares a voltage plane. Thus, each processing core 110 in such an implementation operates at the same voltage as the other ones of processor cores 110. In another implementation, voltage planes are not shared, and thus the supply voltage received by each processing core 110 is set and adjusted independently of the respective supply voltages received by other ones of processor cores 110. Thus, operating point adjustments that include adjustments of a supply voltage can be selectively applied to each processing core 110 independently of the others in implementations having non-shared voltage planes. In the case where changing the operating point includes changing an operating voltage for one or more processor cores 110, system management circuit 125 changes the state of digital signals provided to voltage regulator 165. Responsive to the change in the signals, voltage regulator 165 adjusts the supply voltage provided to the affected ones of processor cores 110. In instances when power is to be removed from (i.e., gated) one of processor cores 110, system management circuit 125 sets the state of corresponding ones of the signals to cause voltage regulator 165 to provide no power to the affected processing core 110.

In various implementations, computing system 100 can be a computer, laptop, mobile device, server, web server, cloud computing server, storage system, or any of various other types of computing systems or devices. It is noted that the number of components of computing system 100 and/or SoC 105 can vary from implementation to implementation. There can be more or fewer of each component/subcomponent than the number shown in FIG. 1. It is also noted that computing system 100 and/or SoC 105 can include other components not shown in FIG. 1. Additionally, in other implementations, computing system 100 and SoC 105 can be structured in other ways than shown in FIG. 1.

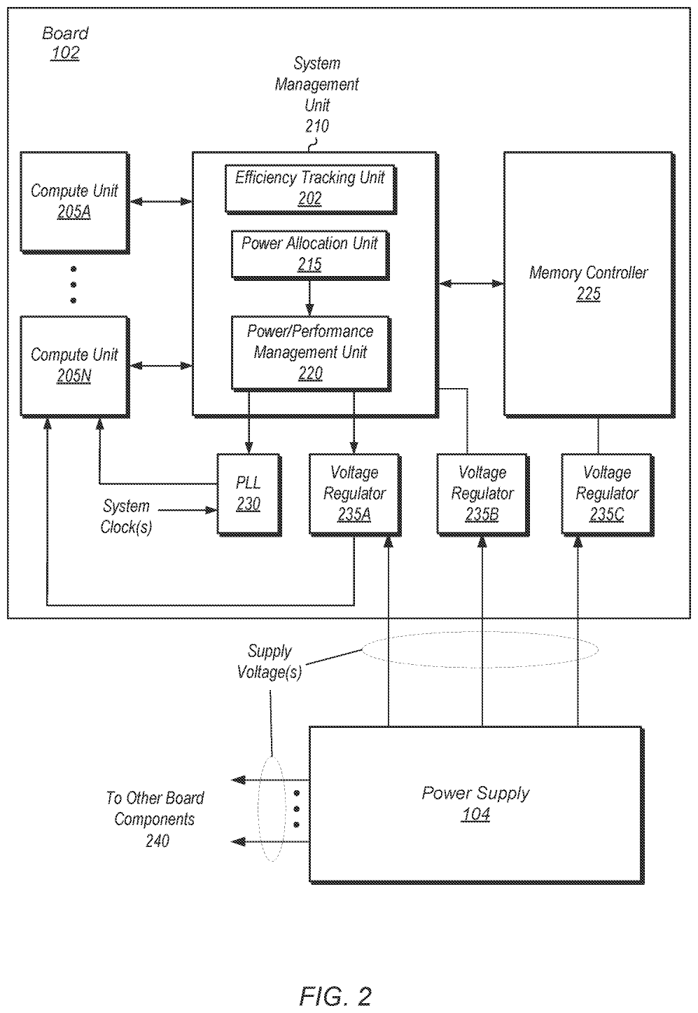

Turning now to FIG. 2, a block diagram of a portion of the board 102 of FIG. 1 coupled to power supply 104 of FIG. 1 is shown. In the example shown, one implementation of a system management circuit 210 is shown. System management circuit 210 is coupled to compute circuits 205A-N, memory controller 225, phase-locked loop (PLL) circuit 230, and voltage regulator 235A. As illustrated, power supply 104 is coupled to supply power to multiple voltage regulators 335A-235C, as well as to other components 240 on the board (not shown). In this example, power supply 104 is shown to supply power to a voltage regulator 235A which is coupled to compute circuit(s) 205, voltage regulator 235B which is coupled to system management circuit 210, and voltage regulator 224 which is coupled to memory controller 225. As may be appreciated, may other voltage regulators and system components are coupled to receive power supplied by power supply 104 and the illustration of FIG. 2 is exemplary only. System management circuit 210 can also be coupled to one or more other components not shown in FIG. 2. Compute circuits 205A-N are representative of any number and type of compute circuits, and compute circuits 205A-N may also be referred to as processors or processing circuits. For example, in one implementation, at least one compute circuit is a CPU and another compute circuit is a GPU.

System management circuit 210 includes efficiency tracking circuit 202, power allocation circuit 215, and power management circuit 220. Efficiency tracking circuit 202 is configured to dynamically track and estimate power efficiency of various components within the system. By dynamically tracking power efficiency (or power losses), the tracking circuit 202 is able to dynamically estimate power consumption. It is noted that the total power consumed is made up of the power consumed by all components of the platform, including the SoC, other components, and other elements of the platform (e.g., power distribution networks, etc.). In this context, the power efficiency or power losses being tracked correspond to the platform as a whole which is not generally tracked as part of the power estimation/tracking of the SoC components. Based on an estimate of power consumed by the SOC and an estimate of the power losses in the board/platform, total power drawn from the power supply can be estimated. Power allocation circuit 215 is configured to allocate a power budget to each of compute circuits 205A-N, to a memory subsystem including memory controller 225, and/or to one or more other components. The total amount of power available to power allocation circuit 215 to be dispersed to the components can be capped for the host system or apparatus. Power allocation circuit 215 receives various inputs from compute circuits 205A-N including a status of the miss status holding registers (MSHRs) of compute circuits 205A-N, the instruction execution rates of compute circuits 205A-N, the number of pending ready-to-execute instructions in compute circuits 205A-N, the instruction and data cache hit rates of compute circuits 205A-N, the consumed memory bandwidth, and/or one or more other input signals. Power allocation circuit 215 can utilize these inputs to determine whether compute circuits 205A-N have tasks to execute, and then power allocation circuit 215 can adjust the power budget allocated to compute circuits 205A-N according to these determinations. Power allocation circuit 215 can also receive inputs from memory controller 225, with these inputs including the consumed memory bandwidth, number of total requests in the pending request queue, number of critical requests in the pending request queue, number of non-critical requests in the pending request queue, and/or one or more other input signals. Power allocation circuit 215 can utilize the status of these inputs to determine the power budget that is allocated to the memory subsystem.

PLL circuit 230 receives system clock signal(s) and includes any number of PLLs configured to generate and distribute corresponding clock signals to each of compute circuits 205A-N and to other components. Power management circuit 220 is configured to convey control signals to PLL circuit 230 to control the clock frequencies supplied to compute circuits 205A-N and to other components. Voltage regulator 235 provides a supply voltage to each of compute circuits 205A-N and to other components. Power management circuit 220 is configured to convey control signals to voltage regulator 235 to control the voltages supplied to compute circuits 205A-N and to other components.

Memory controller 225 is configured to control the memory (not shown) of the host computing system or apparatus. For example, memory controller 225 issues read, write, erase, refresh, and various other commands to the memory. In one implementation, memory controller 225 includes the components of memory controller 225 (of FIG. 2). When memory controller 225 receives a power budget from system management circuit 210, memory controller 225 converts the power budget into a number of memory requests per second that the memory controller 225 is allowed to perform to memory. The number of memory requests per second is enforced by memory controller 225 to ensure that memory controller 225 stays within the power budget allocated to the memory subsystem by system management circuit 210. The number of memory requests per second can also take into account the status of the DRAM to allow memory controller 225 to issue pending critical and non-critical requests to a currently open DRAM row as long as a given memory-power constraint is being met. Memory controller 225 prioritizes processing critical requests without exceeding the requests per second which memory controller 225 is allowed to perform. If all critical requests have been processed and memory controller 225 has not reached the specified requests per second limit, then memory controller 225 processes non-critical requests.

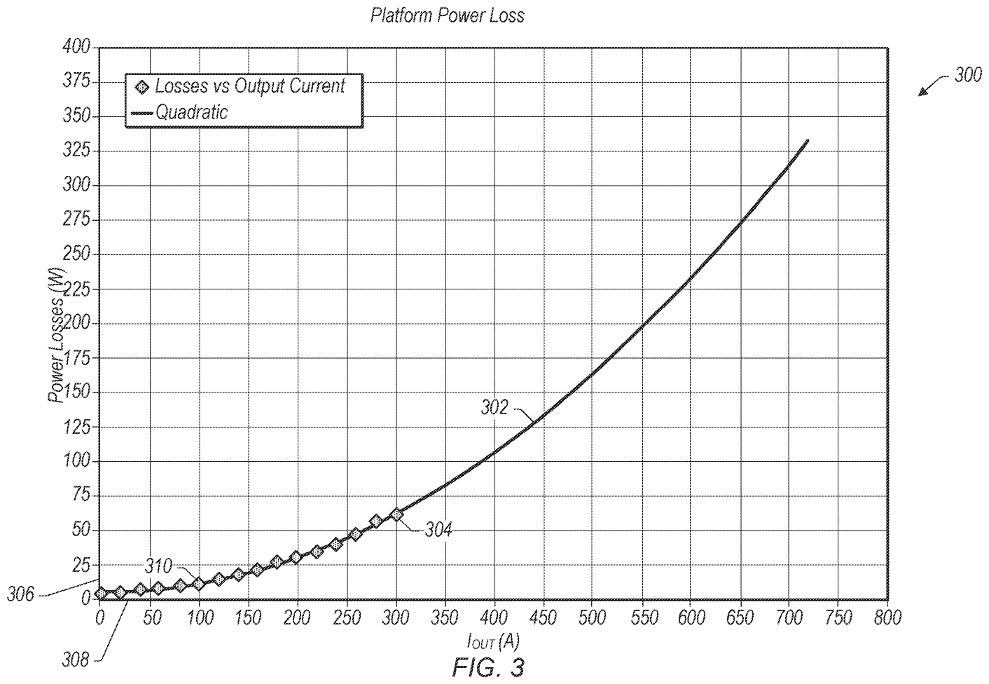

Referring now to FIG. 3, a sample chart is presented which illustrates how power efficiency of the platform can vary depending on various operating conditions. In the example shown, the y-axis enumerates estimated power range losses, Losses (W), (e.g., 0-400 watts) and the x-axis illustrates a range of current being drawn by the platform, Iₒᵤₜ (e.g., 0-800 amperes). As shown, during operation power losses increase as current draw increases. In various implementations, losses may vary based on a variety of conditions including, for example, temperature. For example, when Iₒᵤₜ=100 A, power loss is approximately 10 W. On the other hand, when Iₒᵤₜ=300 W, power loss is approximately 70 W. Further, the relationship can be seen to be non-linear. In the example shown, the relationship between current and power loss is quadratic. Consequently, the rate of power loss in the platform increases as the current increases.

As discussed above, when computing systems are designed, the designers must account for inefficiencies that result in power losses when determining how much power is to be allocated to various components within the system. Designers and vendors of various components used in such computing systems (e.g., processors, memory controller, memories, I/O circuits, etc.) must determine the power requirements for the component under design. For example, GPU designers make assumptions regarding how much power is lost in the power delivery network during operation when determining the power requirements of the GPU. As one example, the GPU designers may determine that the sum of all components of the GPU require, at most, 400 watts of power to operate. Further, it may be determined that 7-15% of power is lost in the power delivery network of the GPU during operation. Taking this estimated power loss into account, the GPU designers determine the actual power budget required to deliver 400 watts of power to the components of the GPU and reports to the platform/board designer that the GPU requires an allocation of more than 400 watts of power to account for these losses. For example, the GPU vendor may report that approximately 400/0.85=471 watts are required by the GPU, assuming only 85% efficiency.

In the above example, the GPU vendor uses the upper part of the power loss range (15% loss) to ensure proper operation of the GPU for all operating conditions. In other words, the GPU vendor assumes worst case power loss and this power loss is statically assumed during operation at all times. However, actual power loss varies during operation and the platform may in fact be operating more efficiently (with respect to power) than the 15% power loss assumption suggests at different times and under different conditions. Consequently, if the GPU is consuming the maximum amount of power based on an estimate that assumes 85% efficiency, the GPU will be constrained from increasing performance any further—even though in reality the GPU is not consuming the maximum amount of power.

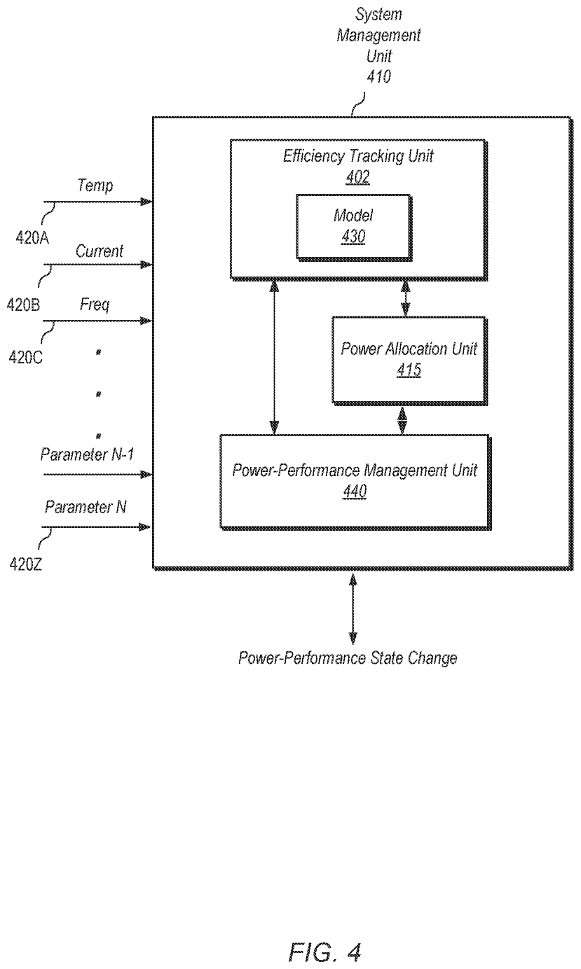

In order to enable the component (the GPU used in this example) to better track power efficiency, in one implementation at least one power efficiency tracking circuit is in incorporated into the system. FIG. 4 illustrates a system management circuit 410 that includes an efficiency tracking circuit 402, power allocation circuit 415, and power/performance management circuit 440. System management circuit 410 is also shown as being configured to receive any number of various system parameters, shown as 420A-420Z, that correspond to conditions, operations, or states of the system. In the example shown, the parameters are shown to include operating temperature 420A of a given circuit(s), current draw by a given circuit(s) 420B, and operating frequency of a given circuit(s). Other parameters are possible and are contemplated. In various implementations, the one or more of the parameters 420 are reported from other circuits or parts of a system (e.g., based on sensors, performance counters, other event/activity detection, or otherwise). In some implementations, one or more parameters are tracked within the system management circuit 410. For example, system management circuit 410 may track current power-performance states of components within the system, duration(s) of power-performance state, previously reported parameters, and so on.

In the example of FIG. 4, efficiency tracking circuit 402 includes model 430. Model 430 is used to estimate a power efficiency of a circuit(s) based on parameters 420. In one implementation, model 430 includes circuitry configured to perform a calculation representative of relationship between power loss and current based on parameters 420. In other implementations, model 430 may include a combination of hardware and software (e.g., firmware) to calculate estimates. In various implementations, the model 430 is developed based at least in part on characterizations of operation of the circuit(s) being tracked. For example, taking the GPU as the example, designers may perform numerous tests to characterize power losses of the GPU during operation under a wide range of conditions. Such conditions include characterizing power losses depending on operating frequency, voltage, current, type of workload (e.g., computation intensive vs memory intensive), circuits in operation, temperature, and so on. Based on these characterizations, a model is developed to represent power loss based on these various conditions. In one implementation, an equation/function representing such a model (as mentioned above) is created to represent the power efficiency of the circuit(s) and circuitry is designed that implements the function. For example, in some implementations the power loss is represented using a simplified model expressed by the equation Pₗₒₛₛ=c₂*Iₒᵤₜ²+c₁*Iₒᵤₜ+c₀. In this example, c is a fixed coefficient that may be determined experimentally, through simulations, or otherwise, and Iₒᵤₜ is the current. In other implementations, a more advanced model may be used that is expressed by the equation Pₗₒₛₛ=f₂ (v, temp)*Iₒᵤₜ²+f₁ (v, temp)*Iₒᵤₜ+f₀ (v, temp). In this model, the coefficients are replaced with functions that are dependent on voltage and temperature. In other implementations, a lookup table or other structure may be used to estimate a current power efficiency. During system operation, the system management circuit 410 monitors estimated power losses based on the estimates of the efficiency tracking circuit 402. Based on the estimated power losses, the system management circuit 410 may change power-performance states of one or more circuits of the system. For example, in one implementation, circuits (e.g., computation circuits) are configured to operate at multiple power-performance states. Given an ample power budget, the computation circuits are able to operate at a higher power performance state and complete work at a faster rate. However, given a reduced power budget, the computation circuits can be limited to a lower power performance state which results in work being completed at a slower rate.

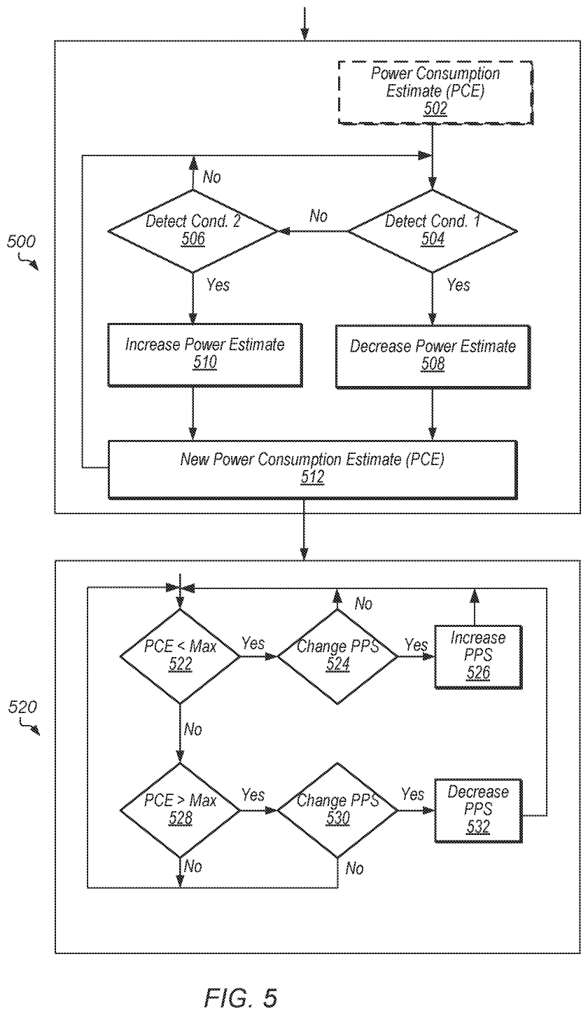

Referring now to FIG. 5, one implementation of how dynamically determined power losses may be used to increase system performance. Two processes are illustrated in FIG. 5, process 500 and process 520. In one implementation, processes 500 and 520 corresponds to functions performed by the system management circuit (e.g., system management circuit 410) to track power efficiency and modify power-performance states based on dynamically determined power consumption estimates. For example, in one implementation, system management circuit 410 includes circuitry configured to perform the functions illustrated by processes 500 and 520. In some implementations, processes 500 and 520 operate concurrently, though this need not be the case.

Process 500 of FIG. 5 corresponds to functions of an efficiency tracking circuit to monitor system conditions (e.g., parameters 420 of FIG. 4, etc.) and dynamically calculate power consumption estimates. As discussed above, a model may be incorporated into the circuit that is used to estimate power losses under various conditions. As noted, traditionally a static assumption is made regarding power losses (e.g., 15%) which is assumed at all times. In the illustrated embodiment, process 500 is shown to include an initial power consumption estimate (PCE) 502. However, other implementations may calculate an initial estimate based on block 512 discussed below. Process 500 is configured to monitor and detect various conditions (e.g., conditions 504 and 506) and calculate a new power consumption estimate based on dynamic detection and estimation of power losses (or power efficiency). It is noted that only two conditions are illustrated to simplify the figure. Implementations may in fact monitor for any number of conditions.

In the example shown, a determination is made as to whether a first condition is detected (504). This condition takes into account the state of the system as represented by parameters received or otherwise made available to the system management circuit (e.g., circuit 410). Based on the state of the system, a determination is made as to whether or not a change in estimated power loss is detected (decision block 504). If a reduction in estimated power loss is detected (i.e., an increase in estimated efficiency), then the current estimated power consumption is decreased (508) and a new power consumption estimate (PCE) is generated or otherwise calculated. Alternatively, if an estimated decrease is not detected (decision block 504), then a determination is made as to whether an increase in estimated power loss is detected (decision block 506). If so, then the estimated power consumption is increased (510) and the new power consumption estimated is generated or otherwise calculated based on the increase (512). If neither condition is detected (504 or 506), monitoring continues until such a condition is detected or some event occurs (e.g., a reboot, power down, reduced power state for the system management circuit, override signal that prevents monitoring, etc.).

As mentioned, processes 500 and 520 operate concurrently in various implementations. Irrespective of whether or not both are operating concurrently at all times or various times, process 520 is configured to make changes to a power-performance state (PPS) of a component(s) within the system based on the estimated power consumption generated by process 500. In various implementations, estimated power consumption is generated by the efficiency tracking circuit 402 and made available to the power-performance management circuit 440 which is configured to perform the functions illustrated by process 520.

In one implementation, process 520 is configured to compare a current estimated power consumption to a maximum power allocated to a given circuit. For example, in one implementation, the given circuit is a GPU. However, in other implementations, the circuit being considered only a portion of the GPU (or other system component. As may be appreciated, the methods and mechanisms described herein are applicable computing circuits at any of a variety of granularities. For example, power consumption for a GPU as a whole can be estimated and acted upon. Alternatively, particular computing circuit(s) of the GPU may be tracked for power efficiency. All such embodiments are possible and are contemplated.

As shown in FIG. 5, a current power consumption estimate (PCE) is compared to the maximum power allocated for the circuit. Using the entire GPU as an example, the platform of which the GPU is a part may have allocated 471 watts of power to the GPU as discussed above. Depending on operating conditions, process 500 may have generated a current estimated power consumption that is less than 471 watts due to an estimated reduction in power losses. If the estimate is lower than the maximum (condition block 522), then it may be possible to increase the PPS of the GPU, or some portion of the GPU, while remaining within the total power limit of the power supply. As shown, a determination is made as to whether a change in power-performance state (PPS) is indicated (condition block 524). For example, if a current task benefits from a higher operating frequency of compute circuits (e.g., a video game in which higher frame rates are desirable), then the power management circuit increases a PPS of the compute circuits. This may entail, or otherwise cause, a higher frequency and voltage to be applied to the compute circuits which consumes additional power. Changing the power-performance state may also include allocating more, or less, of a power budget to a circuit. Subsequent to increasing the PPS of the compute circuits, new estimates will be generated by process 500.

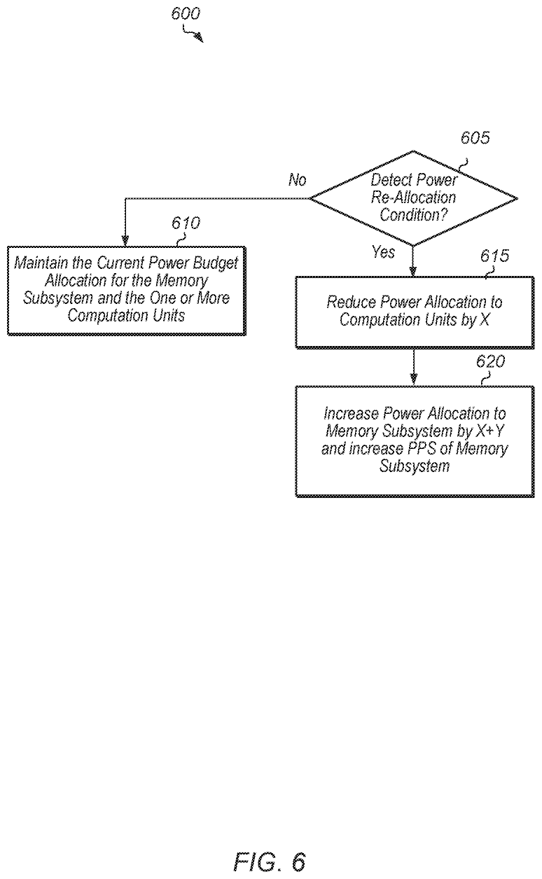

Conversely, if it is determined the PCE exceeds the maximum power allocated (decision block 528), then a PPS of a circuit(s) may be changed if such a change is indicated (condition block 530). In some scenarios, the PCE may be permitted to exceed the maximum for limited periods of time. Otherwise, a PPS change may be indicated and the PPS decreased (block 532). It is noted that the circuit whose PPS is changed by process 520 need not be the circuit(s) being directly tracked for efficiency. For example, if reduced power losses are dynamically detected in the system because one or more first circuits (e.g., circuits A) are operating more power efficiently, then the power saved by circuits A can be allocated for use by one or more different circuits (e.g., circuits B). The system management circuit 410 may be configured to detect scenarios where it is possible to make such allocations. For example, the model(s) developed during characterization(s) may identify such possibilities and various other combinations of system operation that can increase performance in one area when efficiencies improve in other areas. Referring now to FIG. 6, an example of a method 600 for changing power-performance states (PPS) of circuits based on estimated power consumption in a computing system is shown. This example illustrates how re-allocation of power can be modified based on dynamically tracking power efficiencies in a computing system. Generally speaking, a re-allocation of a power budget in the system may remove a portion X of an allocated power budget from one circuit and allocated that portion X to another circuit. However, this example illustrates how the above described dynamic power consumption estimates can alter this re-allocation.

In this example, it is determined that computation circuits are operating with reduced power loss and an increase of a PPS of a memory subsystem is initiated (condition 605). The memory subsystem includes a memory controller and one or more memory devices. In one implementation, the decision to increase a PPS of the memory subsystem is based in part on detecting execution of tasks requiring increased memory bandwidth (e.g., due to type of workload), pending critical memory access requests, or otherwise. Depending on the implementation, the system management circuit can utilize one or more of a number of tasks which the one or more processors have to execute, the current operating point of the one or more processors, the consumed memory bandwidth, the number of critical and non-critical pending requests in the memory controller, the temperature of one or more components and/or the temperature of the entire system, and/or one or more other metrics for determining how much power to allocate to the memory subsystem.

Having detected the condition (condition 605), a power budget allocated to the computation circuits is reduced by an amount X (block 615). This amount X may represent an amount that does not take into account the reduced power losses of the computation circuits. In other words, an algorithm may be established for re-allocating power budgets within the system that does not consider the above described efficiency tracking. For example, power budget re-allocations can occur in the system irrespective of reduced power losses (e.g., due to changes in workload, etc.). Based on this algorithm, it is determined that X is to be reallocated to the memory subsystem. Given the system management circuit 410 is configured to dynamically track power losses and corresponding increased efficiencies, the system management circuit 410 calculates how much of a power budget to transfer to the memory subsystem when the current power losses are taken into consideration. In the example shown, due to reduced power losses, more than the amount X of the power budget removed from the computation circuits can be allocated to the memory subsystem. Therefore, an amount of power X+Y is allocated to the memory subsystem and the PPS, and power consumption, of the memory subsystem is increased to take advantage of this newly allocated power (block 620). It is noted that the converse may occur as well. If relatively high(er) power losses are detected, then when a power budget re-allocation condition is detected, an amount of the power budget re-allocated may be reduced to account for the reduced efficiencies. Numerous such scenarios are possible and are contemplated.

In various implementations, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a system management circuit configured to:
dynamically estimate power consumption of a computing system; and
change a power-performance state of a first circuit of a plurality of circuits of the computing system, responsive to dynamic detection of one of an increase or decrease in power loss in the computing system.

2. The system as recited in claim 1, wherein the system management circuit is configured to dynamically estimate power consumption of each of a plurality of circuits of the computing system.

3. The system as recited in claim 2, wherein in response to detecting decreased power losses in a first circuit of the plurality of circuits, the system management circuit is configured to increase a power-performance state of a second circuit of the plurality of circuits.

4. The system as recited in claim 2, wherein the computing system is a graphics processing circuit and the system management circuit is configured increase a power-performance state of a computation circuit, in response to detecting decreased power losses in a memory subsystem.

5. The system as recited in claim 2, wherein the system management circuit is configured to dynamically estimate power consumption of the computing system based on a state of the computing system, wherein the state is based in part on a plurality of parameters including one or more of an amount of current being drawn, an operating frequency, and operating temperature.

6. The system as recited in claim 1, wherein the system management circuit is configured to dynamically estimate power consumption of the plurality of circuits based in part on a calculation representative of relationship between power loss, current, and one or more of voltage and temperature.

7. The system as recited in claim 1, wherein the system management circuit is configured to:
determine the computing system is estimated to be consuming a maximum amount of power allocated for use by the computer system; and
increase power consumption used by at least a portion of the system without reducing power consumed elsewhere in the system and without increasing estimated power consumption, in response to detecting a condition.

8. The system as recited in claim 7, wherein the condition is dynamically estimating decreased power losses in at least a portion of the computing system.

9. A method comprising:
dynamically estimating power consumption of a computing system; and
changing a power-performance state of a first circuit of a plurality of circuits of the computing system, responsive to dynamically detecting one of an increase or decrease in power loss in the computing system.

10. The method as recited in claim 9, further comprising dynamically estimating power consumption of each of a plurality of circuits of the computing system.

11. The method as recited in claim 9, wherein in response to detecting decreased power losses in a first circuit of the plurality of circuits, the method comprises increasing a power-performance state of a second circuit of the plurality of circuits.

12. The method as recited in claim 10, wherein the computing system is a graphics processing circuit and the method comprises increasing a power-performance state of a computation circuit, in response to detecting decreased power losses in a memory subsystem.

13. The method as recited in claim 10, further comprising dynamically estimating power consumption of the computing system based on a state of the computing system, wherein the state is based in part on a plurality of parameters including one or more of an amount of current being drawn, an operating frequency, and operating temperature.

14. The method as recited in claim 9, further comprising dynamically estimating power consumption of the plurality of circuits based in part on a calculation representative of relationship between power loss, current, and one or more of voltage and temperature.

15. The method as recited in claim 9, further comprising:
determining the computing system is estimated to be consuming a maximum amount of power allocated for use by the computer system; and
increasing power consumption used by at least a portion of the computing system without reducing power consumed elsewhere in the computing system and without increasing estimated power consumption, in response to detecting a condition.

16. The method as recited in claim 15, wherein the condition is dynamically estimating decreased power losses in at least a portion of the computing system.

17. A system comprising:
a plurality of circuits comprising a central processing circuit, a graphics processing circuit, a memory subsystem, and a system management circuit;
wherein the system management circuit configured to:
dynamically estimate power consumption of the plurality of circuits; and
change a power-performance state of a first circuit of a plurality of circuits, responsive to dynamic detection of one of an increase or decrease in power loss in the system.

18. The system as recited in claim 17, wherein in response to detecting decreased power losses in a first circuit of the plurality of circuits, the system management circuit is configured to increase a power-performance state of a second circuit of the plurality of circuits.

19. The system as recited in claim 17, wherein the system management circuit is configured to dynamically estimate power consumption of the plurality of circuits based in part on a calculation representative of relationship between power loss and current.

20. The system as recited in claim 1, wherein the system management circuit is configured to:
determine the computing system is estimated to be consuming a maximum amount of power allocated for use by the computer system; and
increase power consumption used by at least a portion of the system without reducing power consumed elsewhere in the system and without increasing estimated power consumption, in response to detecting a condition.
